(19) United States
(12) Patent Application Publication
(10) Pub. No.: US 2026/0086336 A1
(43) Pub. Date: Mar. 26, 2026

(54) OPTICAL IMAGING LENS

(71) Applicant: GENIUS ELECTRONIC OPTICAL (XIAMEN) CO., LTD., Xiamen (CN)

(72) Inventors: Zhizhong Ji, Xiamen (CN); Fubao Wang, Xiamen (CN); Huaibin Shen, Xiamen (CN)

(73) Assignee: GENIUS ELECTRONIC OPTICAL (XIAMEN) CO., LTD., Xiamen (CN)

(21) Appl. No.: 18/957,912

(22) Filed: Nov. 25, 2024

(30) Foreign Application Priority Data
Sep. 26, 2024 (CN) 202411353853.3

(51) Int. Cl. G02B 13/00; G02B 7/02; G03B 17/12; H04N 23/55

(52) U.S. Cl. CPC G02B 13/006; G02B 7/021; G02B 7/025; G03B 17/12; H04N 23/55

(57) ABSTRACT

An optical imaging lens includes lens elements arranged in sequence along an optical axis from an object side to an image side. Each lens element has an object-side surface facing the object side and an image-side surface facing the image side. Each lens element further includes an optical portion for allowing an imaging ray to pass through and a mounting portion extending radially outwards from an optical boundary. The lens elements are embedded with each other and are integrally assembled through glue. For the lens elements between a first lens element counting from the object side towards the image side and a first lens element counting from the image side towards the object side, the object-side surface of the mounting portion has a first propping surface, a first inclined surface, and at least three glue storage regions. The glue storage regions do not contact one another.

### CROSS-REFERENCE TO RELATED APPLICATION

This application claims the priority benefit of China application serial no. 202411353853.3, filed on Sep. 26, 2024. The entirety of the above-mentioned patent application is hereby incorporated by reference herein and made a part of this specification.

### BACKGROUND

### Technical Field

The disclosure relates to an optical component, and in particular, relates to an optical imaging lens that can be applied to portable electronic devices or products with miniaturization requirements.

### Description of Related Art

Regarding portable electronic devices, as the screen-to-body ratio requirements continue to grow, the sizes of optical imaging lenses are required to become increasingly smaller. However, reducing the image height and the size of the image sensor may affect the resolution and other imaging quality of a lens. Therefore, how to reduce the size of the lens without changing the image height is a problem that needs to break through.

A currently-available lens barrel has three main functions: 1. positioning: to precisely align and assemble the lens elements with the optical axis, 2. protection: to prevent the lens from external damage and dust contamination, and 3. light shielding and aperture: to ensure that light passes through the entire optical system as designed and to avoid light leakage and stray light. When a lens group is not supported and fixed by a lens barrel, the air gap distance between the lenses is difficult to control and is unstable, and the lenses are prone to tilt. Further, the structure between the lenses and the design of glue application must also be coordinated in practice. Therefore, how to reduce the size of the lens while satisfying various quality requirements of the lens is a problem that must be solved.

### SUMMARY

The disclosure provides an optical imaging lens capable of providing a reduced volume while maintaining an image height and satisfying various quality requirements.

An embodiment of the disclosure provides an optical imaging lens including a plurality of lens elements arranged in sequence along an optical axis from an object side to an image side. Each lens element has an object-side surface facing the object side and an image-side surface facing the image side. Each lens element further includes an optical portion for allowing an imaging ray to pass through and a mounting portion extending radially outwards from an optical boundary. The optical boundary is a point at which the radially outermost marginal ray passing through the surface of the lens element intersects the surface of the lens element. The lens elements are embedded with each other and are integrally assembled through glue. For the lens elements between a first lens element counting from the object side towards the image side and a first lens element counting from the image side towards the object side, the object-side surface of the mounting portion has a first propping surface, a first inclined surface, and at least three glue storage regions. The first propping surface is perpendicular to the optical axis, and the first inclined surface is connected to the first propping surface and inclined relative to the optical axis. Each glue storage region has a first flat surface and a second inclined surface, the first flat surface is perpendicular to the optical axis, the second inclined surface is connected to the first flat surface and inclined relative to the optical axis, and the glue storage regions do not contact one another. The image-side surface of the mounting portion has a second propping surface and a third inclined surface, the second propping surface is perpendicular to the optical axis, and the third inclined surface is connected to the second propping surface and inclined relative to the optical axis. Each glue storage region is retracted a distance from the first propping surface and the first inclined surface. The optical imaging lens satisfies the following: 1≤GS_AL/SP_AL≤3 and 5%≤(RGS2−RGS1)/RGS2≤30%, where GS_AL is an arc length of the glue storage region, SP_AL is an arc length of the first propping surface, RGS1 is a shortest distance from the optical axis to the second inclined surface, and RGS2 is a farthest distance from the optical axis to the first flat surface.

In the optical imaging lens of the embodiments of the disclosure, the lens elements are fixed through embedding with the glue to maintain the alignment and stability of the lens elements. For the lens elements between the lens elements in the optical imaging lens, each glue storage region satisfies being retracted a distance, so each glue storage region is provided with a sufficient space to avoid glue overflow. The space of the glue storage region on the second inclined surface may allow the glue to flow down. With this retracted distance, the manufacturing yield is high and glue overflow to the optical portion is avoided. Further, the glue in this space may also adhere to the third inclined surface of the adjacent lens element, so the intensity in different directions of the optical axis is improved. When the optical imaging lens satisfies 1≤GS_AL/SP_AL≤3 and 5%≤(RGS2−RGS1)/RGS2≤30%, pressure may be uniformly distributed on the peripheral mounting portion of each lens element after adhesion with the second propping surface, and the lens elements may thus be well positioned. A more preferable condition is 8.7%≤(RGS2−RGS1)/RGS2≤30%.

When all the aforementioned conditions are satisfied, in the optical imaging lens, the lens elements are embedded with each other and are integrally assembled through the glue, so each glue storage region is provided with a sufficient space to avoid glue overflow, the propping surface is provided with a sufficient area to avoid the risk of assembly inclination, and fixing intensity in the direction of the optical axis and in different directions of the optical axis is also improved. The lens barrel can also be replaced to achieve the function of eliminating the lens barrel. The thickness required by a lens barrel in the external dimension of the entire lens is thereby decreased, so the external dimension of the lens is reduced, various quality requirements of the lens are satisfied, and effects such as weight reduction, cost reduction, and easy assembly are also achieved. Therefore, in the embodiments of the disclosure, the optical imaging lens is capable of providing a reduced volume while maintaining the image height and satisfying various quality requirements.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic cross-sectional view of an optical imaging lens according to Embodiment 1 of the disclosure.

FIG. 2 is a schematic three-dimensional view of a lens element 230 in FIG. 1 illustrating an object-side surface of the lens element 230.

FIG. 3 is a schematic three-dimensional view of a lens element 220 in FIG. 1 illustrating an image-side surface of the lens element 220.

FIG. 4 is a front view of a lens element 250 in FIG. 1 as viewed from an image side.

FIG. 5 is a schematic cross-sectional view of an optical imaging lens according to Embodiment 2 of the disclosure.

FIG. 6 is a schematic cross-sectional view of an optical imaging lens according to Embodiment 3 of the disclosure.

FIG. 7 is a schematic cross-sectional view of an optical imaging lens according to Embodiment 4 of the disclosure.

FIG. 8 is a schematic cross-sectional view of an optical imaging lens according to Embodiment 5 of the disclosure.

FIG. 9 is a schematic cross-sectional view of an optical imaging lens according to Embodiment 6 of the disclosure.

FIG. 10 is a front view of the lens element in FIG. 1 as viewed from an object side.

FIG. 11 is a front view of a lens element as viewed from an object side according to Embodiment 6 of the disclosure.

FIG. 12 is a front view of a lens element as viewed from an object side according to another embodiment of the disclosure.

FIG. 13A and FIG. 13B illustrate various parameters of each lens element of Embodiment 1 of the disclosure.

FIG. 14A and FIG. 14B illustrate various parameters of each lens element of Embodiment 2 of the disclosure.

FIG. 15A and FIG. 15B illustrate various parameters of each lens element of Embodiment 3 of the disclosure.

FIG. 16A and FIG. 16B illustrate various parameters of each lens element of Embodiment 4 of the disclosure.

FIG. 17A and FIG. 17B illustrate various parameters of each lens element of Embodiment 5 of the disclosure.

FIG. 18A and FIG. 18B illustrate various parameters of each lens element of Embodiment 6 of the disclosure.

### DESCRIPTION OF THE EMBODIMENTS

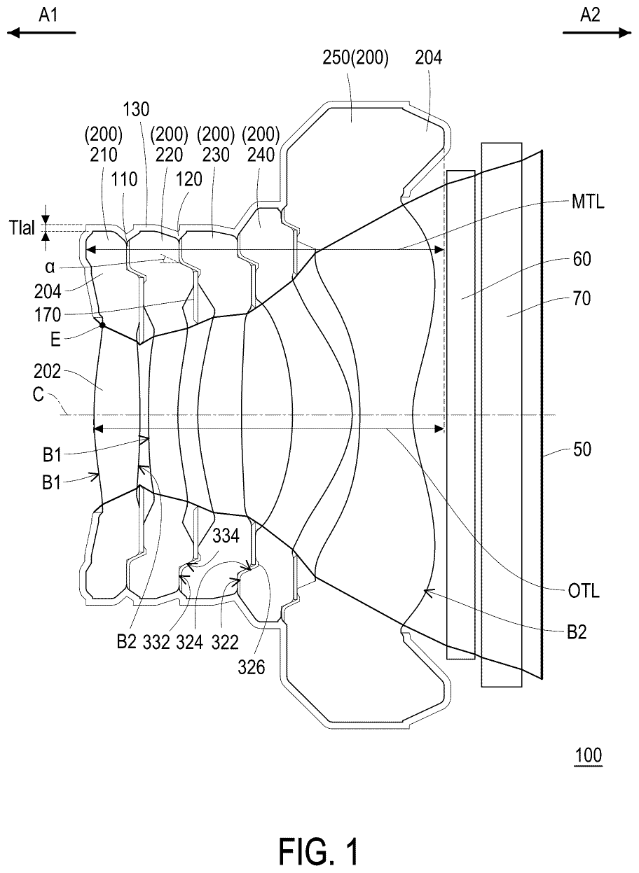

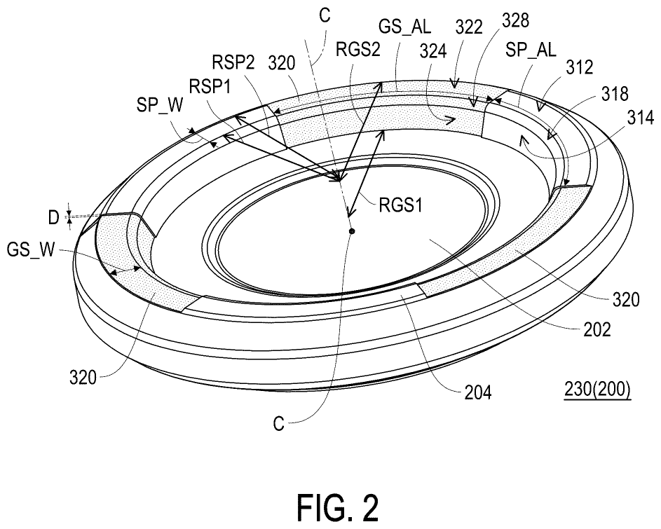

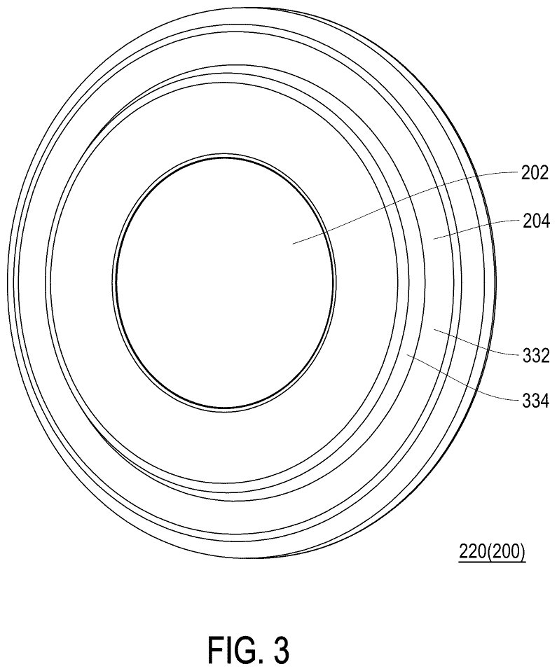

FIG. 1 is a schematic cross-sectional view of an optical imaging lens according to an embodiment of the disclosure. FIG. 2 is a schematic three-dimensional view of a lens element 230 in FIG. 1 illustrating an object-side surface of the lens element 230. FIG. 3 is a schematic three-dimensional view of a lens element 220 in FIG. 1 illustrating an image-side surface of the lens element 220. In FIG. 2 and FIG. 3, gate features of the lens elements are omitted and not shown, but the embodiments of the disclosure may or may not have gates on the lens elements. With reference to FIG. 1 and FIG. 2, an optical imaging lens 100 of this embodiment includes a plurality of lens elements 200. In FIG. 1, these lens elements 200 are, for example, a lens element 210, a lens element 220, a lens element 230, a lens element 240, and a lens element 250 arranged in sequence along an optical axis C from an object side A1 to an image side A2. Each lens element 200 has an object-side surface B1 facing the object side A1 and an image-side surface B2 facing the image side A2. Each lens element 200 further includes an optical portion 202 for allowing an imaging ray to pass through and a mounting portion 204 extending radially outwards from an optical boundary E. The optical boundary E is a point at which the radially outermost marginal ray passing through a surface of the lens element 200 intersects the surface (e.g., object-side surface B1 or image-side surface B2) of the lens element 200. These lens elements are embedded with each other and are integrally assembled through glue 110. For the lens elements (i.e., lens elements 220, 230, and 240) between a first lens element (i.e., lens element 210) counting from the object side A1 towards the image side A2 and a first lens element (i.e., lens element 250) counting from the image side A2 towards the object side A1, the object-side surface B1 of the mounting portion 204 has a first propping surface 312, a first inclined surface 314, and at least three glue storage regions 320 (FIG. 2 shows an example with three glue storage regions 320). The first propping surface 312 is perpendicular to the optical axis C, and the first inclined surface 314 is connected to the first propping surface 312 and inclined relative to the optical axis C. In an embodiment, the first inclined surface 314 is directly connected to the first propping surface 312 by a rounded corner 318 to facilitate demolding, but the disclosure is not limited thereto. Each glue storage region 320 has a first flat surface 322 and a second inclined surface 324, the first flat surface 322 is perpendicular to the optical axis C, the second inclined surface 324 is connected to the first flat surface 322 and inclined relative to the optical axis C, and the glue storage regions 320 do not contact one another. In an embodiment, the second inclined surface 324 is directly connected to the first flat surface 322 by a rounded corner 328 to facilitate demolding, but the disclosure is not limited thereto. The image-side surface B2 of the mounting portion 204 has a second propping surface 332 and a third inclined surface 334, the second propping surface 332 is perpendicular to the optical axis C, and the third inclined surface 334 is connected to the second propping surface 332 and inclined relative to the optical axis C. Each glue storage region 320 is retracted a distance from the first propping surface 312 and the first inclined surface 314. The optical imaging lens satisfies the following: 1≤GS_AL/SP_AL≤3 and 5%≤(RGS2−RGS1)/RGS2≤30%, where GS_AL is an arc length of the glue storage region 320, SP_AL is an arc length of the first propping surface 312, RGS1 is a shortest distance from the optical axis C to the second inclined surface 324, and RGS2 is a farthest distance from the optical axis to the first flat surface 322.

In the optical imaging lens 100 of this embodiment, the lens elements 200 are fixed through embedding and the glue 110 to maintain the alignment and stability of the lens elements 200. For the lens elements 200 (e.g., lens elements 220, 230, and 240) between the lens elements 200 in the optical imaging lens 100, each glue storage region 320 satisfies being retracted a distance D, so each glue storage region 320 is provided with a sufficient space to avoid glue overflow. The space of the glue storage region 320 on the second inclined surface 342 may allow the glue 110 to flow down. With this retracted distance D, the manufacturing yield is high and glue overflow to the optical portion 202 is avoided. Further, the glue 110 in this space may also adhere to the third inclined surface 334 of the adjacent lens element 200, so intensity in different directions of the optical axis C is improved. When the optical imaging lens 100 satisfies 1≤GS_AL/SP_AL and 5%≤(RGS2−RGS1)/RGS2≤30%, pressure may be uniform distributed on the peripheral mounting portion 204 of each lens element 200 after adhesion with the second propping surface 332, and the lens elements 200 may thus be well positioned. More preferable conditions are 1≤GS_AL/SP_AL≤3 and 8.7%≤(RGS2−RGS1)/RGS2≤30%. If the optical imaging lens 100 does not have a lens barrel, it mainly relies on the adhesion of the glue 110, so each glue storage region may have a slightly higher proportion than the first propping surface 312, but does not need to be excessively large in area.

When all the aforementioned conditions are satisfied, in the optical imaging lens 100, the lens elements are embedded with each other and are integrally assembled through the glue 110, so each glue storage region 320 is provided with a sufficient space to avoid glue overflow, the first propping surface 312 is provided with a sufficient area to avoid the risk of assembly inclination, and fixing intensity in the direction of the optical axis C and in different directions of the optical axis C is also improved. The lens barrel can also be replaced to achieve the function of eliminating the lens barrel. Regarding an external dimension of the entire optical imaging lens 100, a thickness required by the lens barrel is decreased, so the external dimension of the lens is decreased, various quality requirements of the lens are satisfied, and effects such as weight reduction, cost reduction, and easy assembly are also achieved. Therefore, in the embodiments of the disclosure, the optical imaging lens 100 is capable of providing a reduced volume while maintaining the image height and satisfying various quality requirements.

In this embodiment, the optical imaging lens 100 does not have a lens barrel, and the mounting portion 204 of the first lens element (i.e., the lens element 250) counting from the image side A2 towards the object side A1 is suitable for directly contacting an image sensor or a voice coil motor arranged on an imaging plane 50. When the optical imaging lens 100 is assembled with a carrier of the voice coil motor, the quality is not affected by the contraction and pulling during the curing of glue application on the carrier. Because the optical imaging lens 100 does not have a lens barrel, it may directly contact corresponding components. The components may be parts other than the optical imaging lens, such as the image sensor of a module, a flexible printed circuit board (PCB), or the carrier, and the volume is thereby reduced.

In this embodiment, the first flat surface 322 satisfies 0.08 mm≤GS_W≤0.32 mm, where GS_W is a width of the first flat surface 322 in a radial direction of the optical axis C. Herein, the radial direction of the optical axis C is the direction perpendicular to the optical axis C, that is, on a plane perpendicular to the optical axis C, with an intersection point of the optical axis C and this plane as a center, radiating outward along this plane. When this condition is satisfied, each glue storage region 320 is provided with a sufficient space to avoid glue overflow.

In this embodiment, the glue storage regions 320 satisfy 2πRGS1/0.25/2 ≥N≥3, where N is the number of the glue storage regions. When this condition is satisfied, the uniform distribution of pressure over a 360-degree circumference after adhesion with the second propping surface 332 is achieved.

In this embodiment, the optical imaging lens 100 satisfies 35 degrees/mm≤α/SP_W≤610 degrees/mm, where α is an angle of inclination relative to the optical axis C of any one of the first inclined surface 314, the second inclined surface 324, and the third inclined surface 334, and SP_W is a width of the first propping surface 312 in the radial direction of the optical axis C. Satisfying this condition is favorable for the embedding and propping among the lens elements 200 and the demolding of the lens elements 200, and more preferable ranges are 37 degrees/mm≤α/SP_W≤560 degrees/mm and 20 degrees≤α≤35 degrees.

In this embodiment, from a portion of the object-side surface B1 of the mounting portion 204 of the first lens element 200 (i.e., lens element 210) counting from the object side A1 towards the image side A2 closest to the object side A1 to a portion of the image-side surface B2 of the first lens element 200 (i.e., lens element 250) counting from the image side A2 towards the object side A1 closest to the image side A2, a maximum height MTL is provided along the optical axis C. From a portion of the object-side surface B1 of the optical portion 202 of the first lens element 200 (i.e., lens element 210) counting from the object side A1 towards the image side A2 closest to the object side A1 to a portion of the image-side surface B2 of the first lens element 200 (i.e., lens element 250) counting from the image side A2 towards the object side A1 closest to the image side A2, a maximum height OTL is provided along the optical axis C. Further, the optical imaging lens 100 satisfies 0.01 mm≤MTL-OTL≤0.07 mm. When this condition is satisfied, the optical portion 202 of each lens element 200 is protected, and the mounting portion 204 may block stray light without blocking incident light at an optimal distance.

In this embodiment, these mounting portions 204 of the entire optical imaging lens 100 are further reinforced by adding additional glue 120 applied in recessed regions among adjacent lens elements 200, so that the entire optical imaging lens 100 may be fixed to maintain the alignment and stability of these lens elements 200. However, the disclosure is not limited thereto.

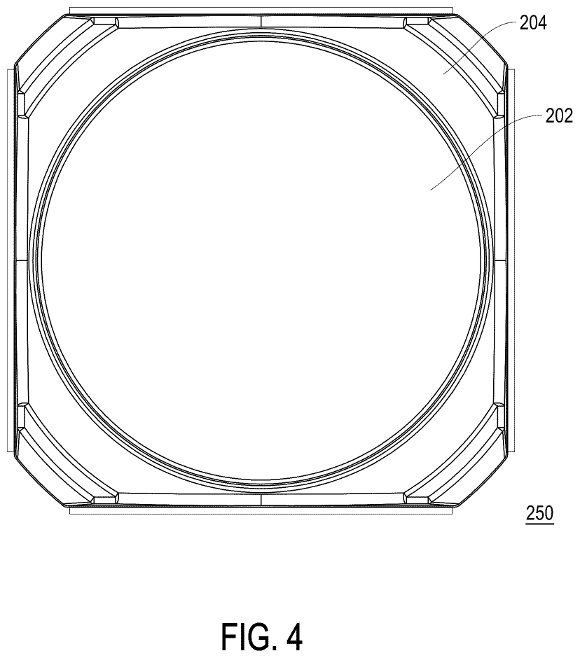

FIG. 4 is a front view of the lens element 250 in FIG. 1 as viewed from the image side. With reference to FIG. 1 to FIG. 4, in this embodiment, a shape of the mounting portion 204 of the first lens element 200 (i.e., lens element 250) counting from the image side A2 towards the object side A1 is square, that is, when observing the mounting portion 204 of the lens element 250 from the image side A2 in the direction of the optical axis C, it may be found that its outer contour is square. Such a design allows the optical imaging lens 100 to be matched with a module end.

In this embodiment, light-absorbing films 130 are individually arranged on these mounting portions 204 of these lens elements 200. Compared to blackening the entire optical imaging lens 100, individually producing the light-absorbing films 130 on the mounting portions 204 may result in more uniform light-absorbing films 130 and improved yield in the blackening process, and the effect of blocking stray light may further by enhanced.

In this embodiment, a thickness Tlal of the light-absorbing film 130 falls within a range of 0.001 millimeter (mm) to 0.05 mm, and stray light in the optical imaging lens 100 is decreased in this way. The blackening treatment may be coating, and it may also be implemented by spraying black or film deposition methods.

In this embodiment, the first propping surface 312 satisfies 0.08 mm≤SP_W≤0.31 mm, where SP_W is the width of the first propping surface 312 in the radial direction of the optical axis C. Satisfying this condition is favorable for the propping between adjacent lens elements 200 and avoiding the risk of yield reduction caused by insufficient propping area, which may result in ineffective propping and inclination during the assembly of the optical imaging lens 100.

In this embodiment, the optical imaging lens satisfies 3%≤(RSP2−RSP1)/RSP2≤14.2%, where RSP1 is a shortest distance from the optical axis C to the first propping surface 312, and RSP2 is a farthest distance from the optical axis C to the first propping surface 312. When this condition is satisfied, a sufficient propping surface is provided, an excessively large width is not required, which is conducive to the propping between adjacent lens elements 200. The risk of yield reduction caused by insufficient propping area, which may result in ineffective propping and inclination during the assembly of the optical imaging lens, is thereby avoided. A more preferable condition is 3%≤(RSP2−RSP1)/RSP2≤13%.

In this embodiment, the optical imaging lens 100 satisfies 5≤GS_AL/D/10≤113, where D is a distance that each glue storage region 320 is retracted from the first propping surface 312 and the first inclined surface 314. When each glue storage region 320 satisfies GS_AL>0.25 mm, glue may be applied to the glue storage region 320, so the risk of yield reduction caused by de-centering of the optical imaging lens 100 due to glue overflow onto the first propping surface 312 caused by needle size and coating errors is prevented from occurring. A more preferable condition is 0.5 mm<GS_AL≤5.5 mm. When each glue storage region 320 is retracted by 0.005 mm to 0.02 mm from the first propping surface 312 and the first inclined surface 314, each glue storage region 320 is provided with a sufficient space to avoid glue overflow. The space of the glue storage region 320 on the second inclined surface 324 may allow the glue 110 to flow down. With this retracted distance D, the manufacturing yield is high and glue overflow to the optical portion 202 is avoided. Further, the glue in this space may also adhere to the third inclined surface 334 of the adjacent lens element 200, so the intensity in different directions of the optical axis C is improved. A more preferable condition is 6.2≤GS_AL/D/10≤110.

In this embodiment, a groove 326 (as shown in FIG. 1) is arranged between the second inclined surface 324 and the optical axis C, so another buffer space is provided to the glue storage region 320. With this groove 326, the manufacturing yield is high and glue may not overflow onto the optical portion 202. In an embodiment, the groove 326 may be arranged to encircle the optical axis C for one round.

In this embodiment, a filter 60 (e.g., an infrared cut-off filter) may be arranged between the lens element 250 and the imaging plane 50. In addition, a cover plate 70 may be arranged between the lens element 250 and the imaging plane 50 (for example, between the filter 60 and the imaging plane 50). Further, in this embodiment, a light-shielding sheet 170 may be arranged between the mounting portions 204 of two adjacent lens elements 200 to suppress stray light.

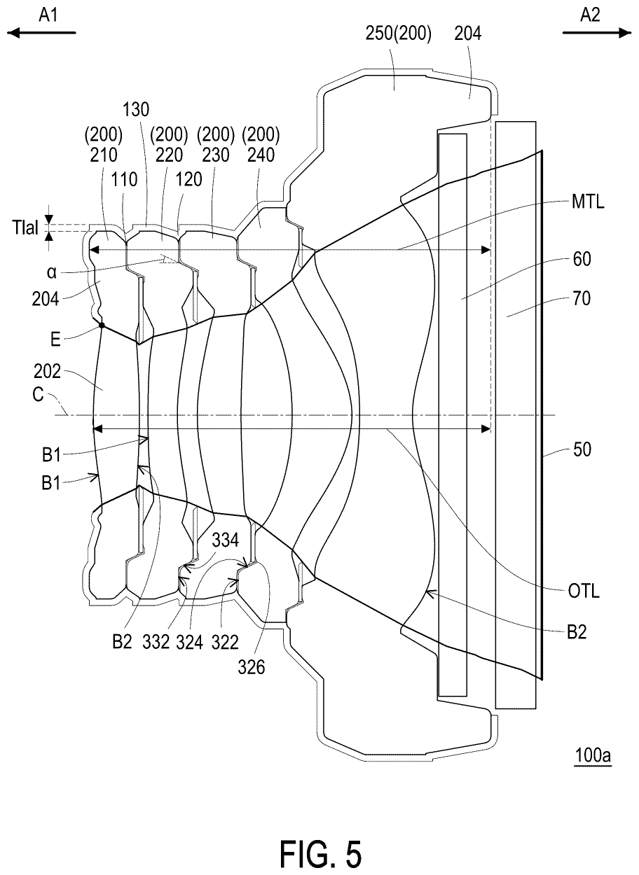

FIG. 5 is a schematic cross-sectional view of an optical imaging lens according to Embodiment 2 of the disclosure. With reference to FIG. 5, an optical imaging lens 100a of this embodiment is similar to the optical imaging lens 100 in FIG. 1, and the main differences therebetween are described as follows. In the optical imaging lens 100a of this embodiment, the mounting portion 204 of the lens element 250 extends to the cover plate 70. The similarity between FIG. 5 and FIG. 1 is that the angle α at which any of the first inclined surface 314, the second inclined surface 324, and the third inclined surface 334 of each lens element 200 (e.g., lens elements 210, 220, 230, 240, and 250) is inclined relative to the optical axis C is equal, but the disclosure is not limited thereto.

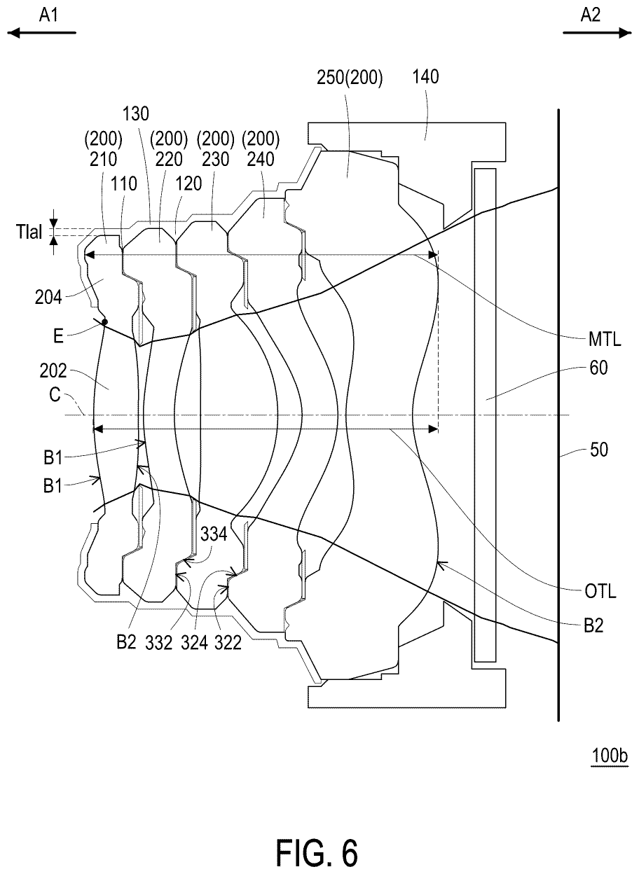

FIG. 6 is a schematic cross-sectional view of an optical imaging lens according to Embodiment 3 of the disclosure. With reference to FIG. 6, an optical imaging lens 100b of this embodiment is similar to the optical imaging lens 100 in FIG. 1, and the main differences therebetween are described as follows. The optical imaging lens 100b of this embodiment further includes a holder 140 fixing the lens element 200 (i.e., lens element 250) closest to the image side A2. The holder 140 is suitable for being connected to an image sensor made by a module manufacturer.

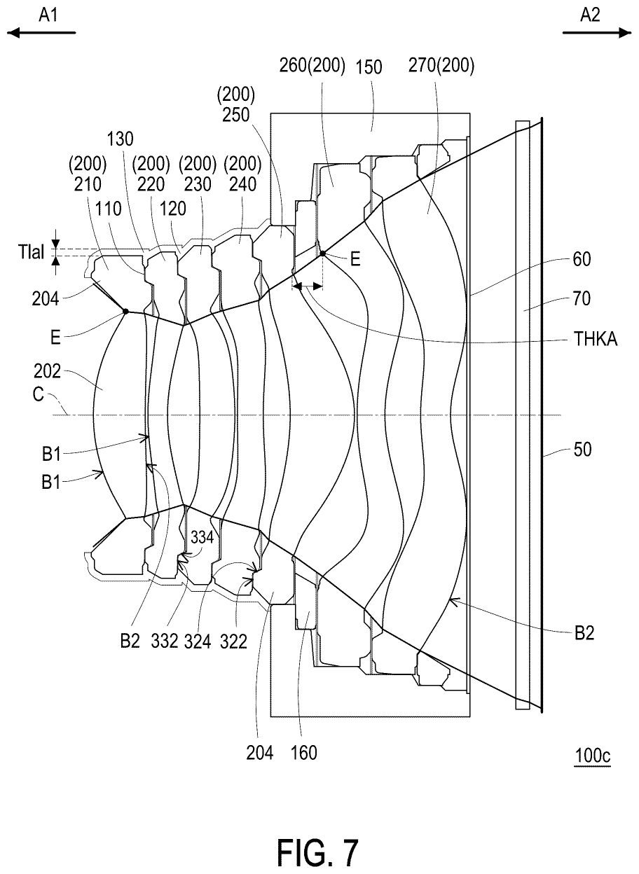

FIG. 7 is a schematic cross-sectional view of an optical imaging lens according to Embodiment 4 of the disclosure. With reference to FIG. 7, an optical imaging lens 100c of this embodiment is similar to the optical imaging lens 100 in FIG. 1, and the main differences therebetween are described as follows. In the optical imaging lens 100c of this embodiment, these lens elements 200 further include a lens element 260 and a lens element 270, the lens element 270 is the lens element closest to the image side A2 among these lens elements 200, and the optical imaging lens 100c has a lens barrel 150. The lens barrel 150 accommodates a front lens element (e.g., lens element 250), a spacer 160, and a rear lens element (e.g., lens element 260) of the optical imaging lens 100c from the object side A1 to the image side A2. In this embodiment, the lens barrel 150 also accommodates the lens element 270. The spacer 160 is arranged between the front lens element (e.g., lens element 250) and the rear lens element (e.g., lens element 260) and satisfies 0.2 mm≤THKA≤1.3 mm, where THKA is a maximum distance parallel to the optical axis C from the mounting portion 204 of the front lens element (e.g., lens element 250) to the mounting portion 204 of the rear lens element (e.g., lens element 260). This design is favorable when the optical boundaries E of the last three lens elements 200 (i.e., lens elements 250, 260, and 270) of the optical imaging lens 100c differ significantly and need to be assembled with the spacer 160. The lens barrel 150 only needs to accommodate the last three lens elements 200 to achieve protection of the optical imaging lens 100c and can be directly connected to the image sensor of the module to measure various optical imaging quality, so the production yield is improved.

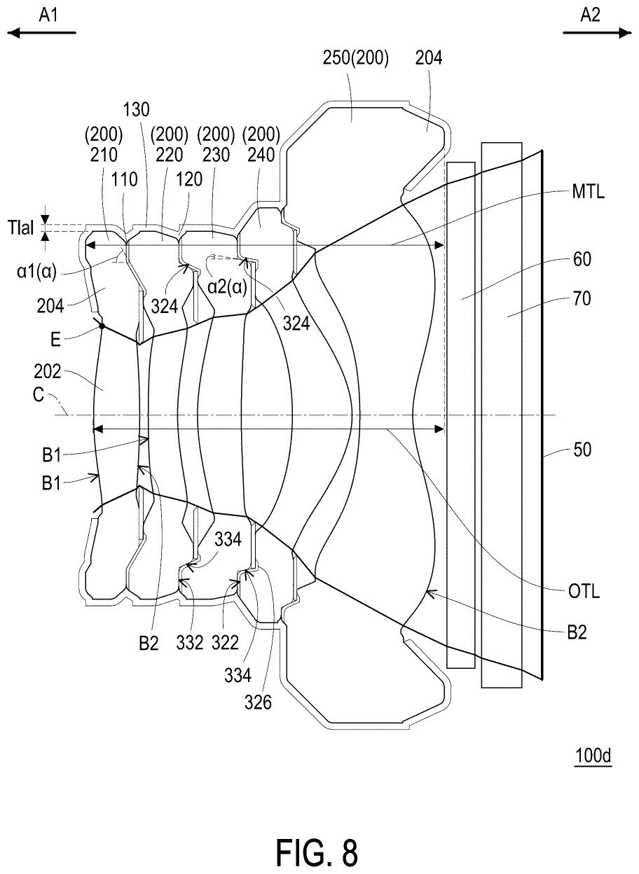

FIG. 8 is a schematic cross-sectional view of an optical imaging lens according to Embodiment 5 of the disclosure. With reference to FIG. 8, an optical imaging lens 100d of this embodiment is similar to the optical imaging lens 100 in FIG. 1, and the main differences therebetween are described as follows. The angle α of the optical imaging lens 100d in this embodiment has more than one angle, for example, it has two angles α1 and α2. For instance, the angle α1 at which the first inclined surface 314 and the second inclined surface 324 of the lens element 230 and the third inclined surface 334 of the lens element 220 are inclined relative to the optical axis C may be 60 degrees, while the angle α2 at which the first inclined surface 314 and the second inclined surface 324 of the lens element 240 and the third inclined surface 334 of the lens element 230 are inclined relative to the optical axis C may be 10 degrees.

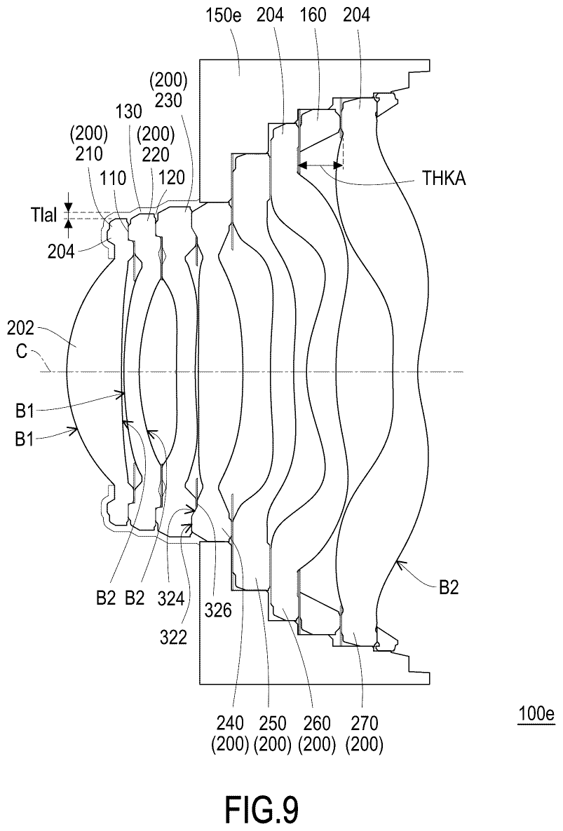

FIG. 9 is a schematic cross-sectional view of an optical imaging lens according to Embodiment 6 of the disclosure. With reference to FIG. 9, an optical imaging lens 100e of this embodiment is similar to the optical imaging lens 100c in FIG. 7, and the main differences therebetween are described as follows. In the optical imaging lens 100e of this embodiment, a lens barrel 150e accommodates the lens elements 240, 250, 260, and 270 and the spacer 160. The spacer 160 is arranged between the mounting portion 204 of the lens element 260 and the mounting portion 204 of the lens element 270. The maximum distance THKA between the mounting portion 204 of the lens element 260 and the mounting portion 204 of the lens element 270 parallel to the optical axis C may be 0.986 mm.

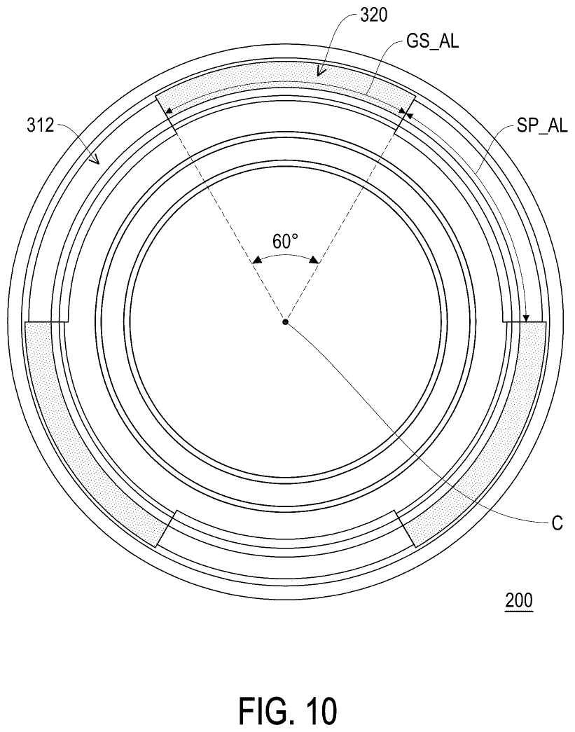

FIG. 10 is a front view of the lens element in FIG. 1 as viewed from the object side. With reference to FIG. 1, FIG. 2, and FIG. 10, in FIG. 2 and FIG. 10, GS_AL/SP_AL=1, the number of the glue storage regions 320 is 3, and the angle that each glue storage region 320 extends relative to the optical axis C is 60 degrees.

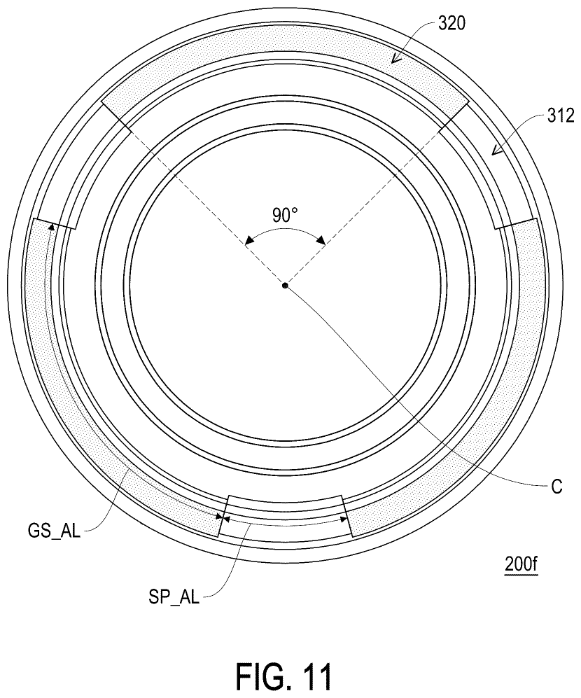

FIG. 11 is a front view of a lens element as viewed from the object side according to Embodiment 6 of the disclosure. With reference to FIG. 11, in this embodiment, GS_AL/SP_AL=3, the number of the glue storage regions 320 is 3, and the angle that each glue storage region 320 extends relative to the optical axis C is 90 degrees.

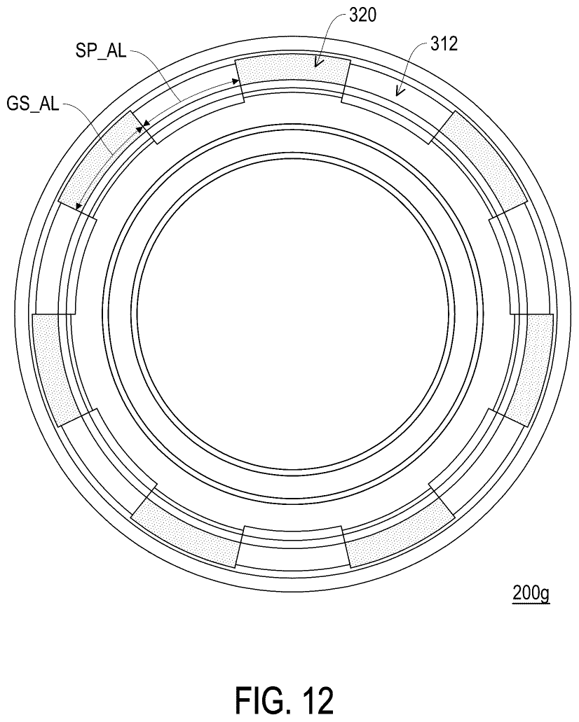

FIG. 12 is a front view of a lens element as viewed from the object side according to another embodiment of the disclosure. With reference to FIG. 12, in this embodiment, GS_AL/SP_AL=1, the number of the glue storage regions 320 is 7, and GS_AL is 0.5 mm, for example. In an embodiment, GS_AL is 0.5 mm with a minimum of 0.25 mm.

In the lens elements shown in FIG. 10 to FIG. 12, gate features of the lens elements are omitted and not shown, but the embodiments of the disclosure may or may not have gates on the lens elements.

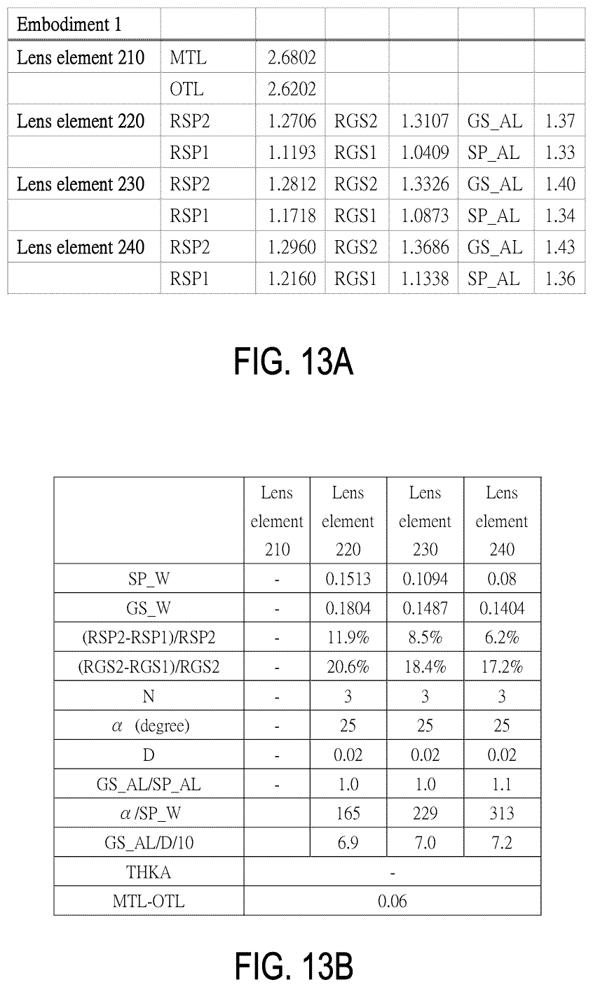

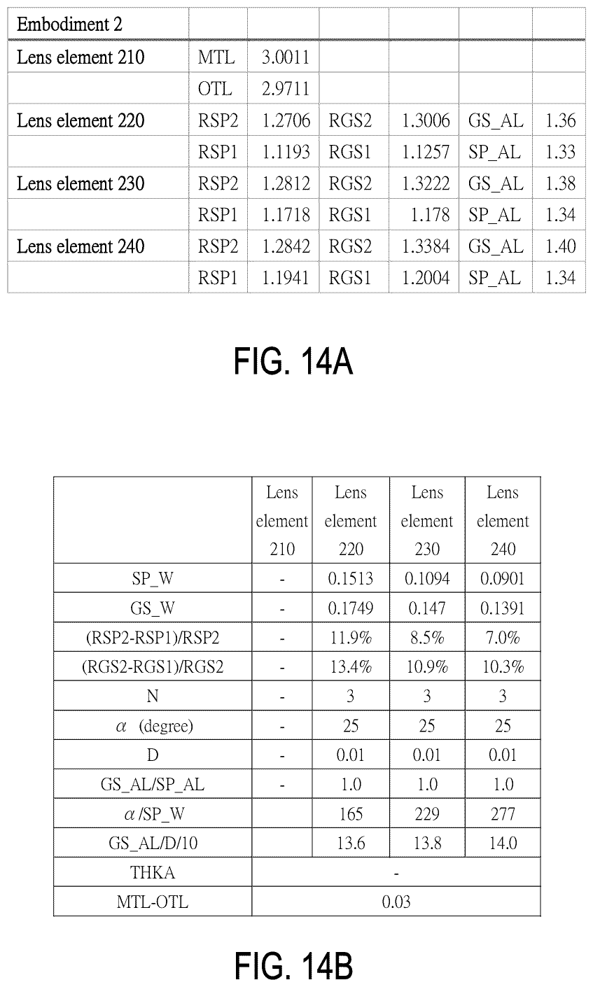

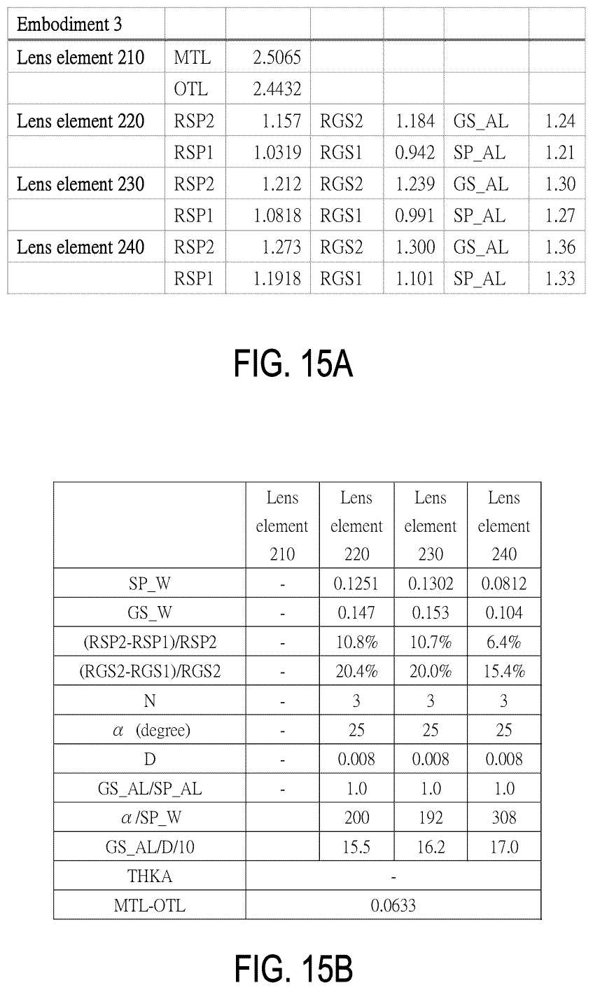

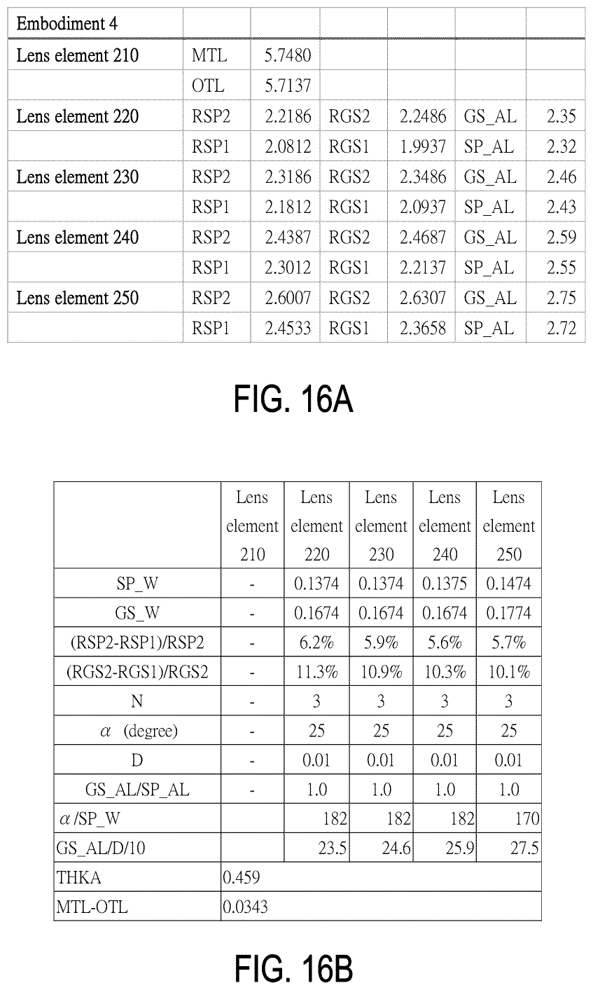

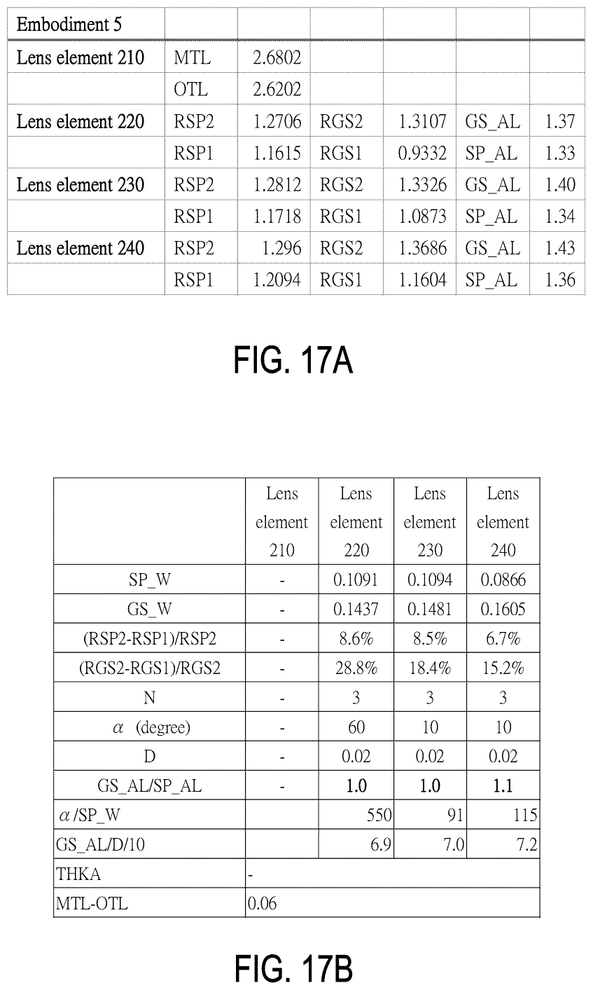

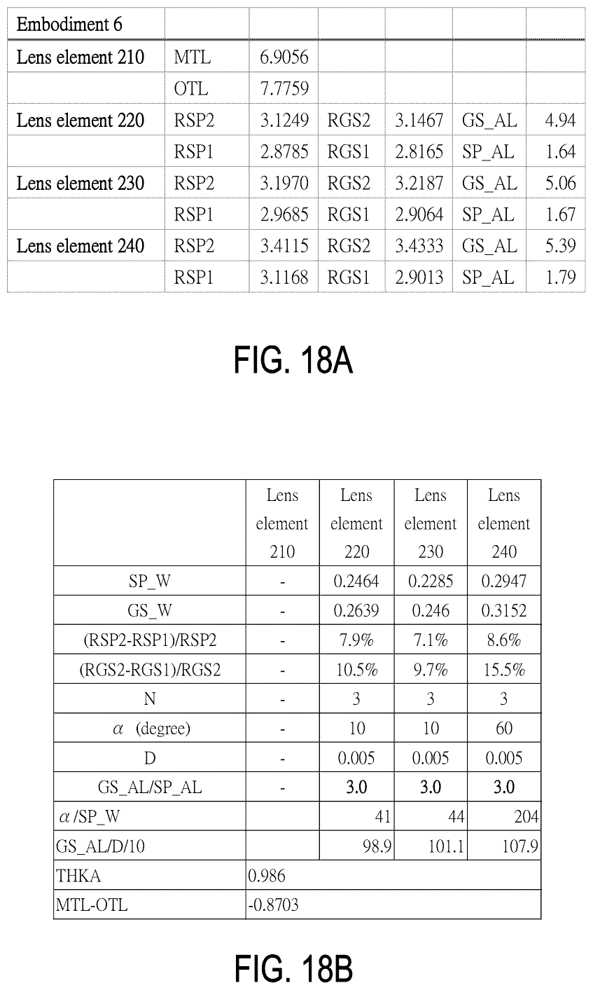

FIG. 13A and FIG. 13B illustrate various parameters of each lens element of Embodiment 1 of the disclosure. FIG. 14A and FIG. 14B illustrate various parameters of each lens element of Embodiment 2 of the disclosure. FIG. 15A and FIG. 15B illustrate various parameters of each lens element of Embodiment 3 of the disclosure. FIG. 16A and FIG. 16B illustrate various parameters of each lens element of Embodiment 4 of the disclosure. FIG. 17A and FIG. 17B illustrate various parameters of each lens element of Embodiment 5 of the disclosure. FIG. 18A and FIG. 18B illustrate various parameters of each lens element of Embodiment 6 of the disclosure. For the parameters with units in FIG. 13A to FIG. 18B, their units are as recorded in the text of the above-mentioned embodiments. Please refer to the units in the text of the above-mentioned embodiments, and description thereof is not be repeated herein.

In view of the foregoing, in the optical imaging lens of the embodiments of the disclosure, the lens elements are fixed through embedding and the glue to maintain the alignment and stability of the lens elements. For the lens elements between the lens elements in the optical imaging lens, each glue storage region satisfies being retracted a distance, so each glue storage region is provided with a sufficient space to avoid glue overflow. The space of the glue storage region on the second inclined surface may allow the glue to flow down. With this retracted distance, the manufacturing yield is high and glue overflow to the optical portion is avoided. Further, the glue in this space may also adhere to the third inclined surface of the adjacent lens element, so the intensity in different directions of the optical axis is improved. When the optical imaging lens satisfies 1≤GS_AL/SP_AL≤3 and 5%≤(RGS2−RGS1)/RGS2≤30%, pressure may be uniformly distributed on the peripheral mounting portion of each lens element after adhesion with the second propping surface, and the lens elements may thus be well positioned.

When all the aforementioned conditions are satisfied, in the optical imaging lens, the lens elements are embedded with each other and are integrally assembled through the glue, so each glue storage region is provided with a sufficient space to avoid glue overflow, the propping surface is provided with a sufficient area to avoid the risk of assembly inclination, and fixing intensity in the direction of the optical axis and in different directions of the optical axis is also improved. The lens barrel can also be replaced to achieve the function of eliminating the lens barrel. The thickness required by a lens barrel in the external dimension of the entire lens is thereby decreased, so the external dimension of the lens is reduced, various quality requirements of the lens are satisfied, and effects such as weight reduction, cost reduction, and easy assembly are also achieved. Therefore, in the embodiments of the disclosure, the optical imaging lens is capable of providing a reduced volume while maintaining the image height and satisfying various quality requirements.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An optical imaging lens, comprising:
a plurality of lens elements arranged in sequence along an optical axis from an object side to an image side, wherein
each lens element has an object-side surface facing the object side and an image-side surface facing the image side,
each lens element further comprises an optical portion for allowing an imaging ray to pass through and a mounting portion extending radially outwards from an optical boundary, and the optical boundary is a point at which the radially outermost marginal ray passing through a surface of the lens element intersects the surface of the lens element,
the lens elements are embedded with each other and are integrally assembled through glue,
for the lens elements between a first lens element counting from the object side towards the image side and a first lens element counting from the image side towards the object side, the object-side surface of the mounting portion has a first propping surface, a first inclined surface, and at least three glue storage regions, the first propping surface is perpendicular to the optical axis, and the first inclined surface is connected to the first propping surface and inclined relative to the optical axis,
each glue storage region has a first flat surface and a second inclined surface, the first flat surface is perpendicular to the optical axis, the second inclined surface is connected to the first flat surface and inclined relative to the optical axis, and the glue storage regions do not contact one another,
the image-side surface of the mounting portion has a second propping surface and a third inclined surface, the second propping surface is perpendicular to the optical axis, and the third inclined surface is connected to the second propping surface and inclined relative to the optical axis,
each glue storage region is retracted a distance from the first propping surface and the first inclined surface, and
the optical imaging lens satisfies the following: 1≤GS_AL/SP_AL≤3 and 5%≤(RGS2−RGS1)/RGS2≤30%, where GS_AL is an arc length of the glue storage region, SP_AL is an arc length of the first propping surface, RGS1 is a shortest distance from the optical axis to the second inclined surface, and RGS2 is a farthest distance from the optical axis to the first flat surface.

2. The optical imaging lens according to claim 1, wherein the optical imaging lens does not have a lens barrel, and the mounting portion of the first lens element counting from the image side towards the object side is suitable for directly contacting an image sensor or a voice coil motor.

3. The optical imaging lens according to claim 1, wherein the first flat surface satisfies 0.08 mm ≤GS_W≤0.32 mm, where GS_W is a width of the first flat surface in a radial direction of the optical axis.

4. The optical imaging lens according to claim 1, wherein the glue storage regions satisfy 2πRGS1/0.25/2≥N≥3, where N is the number of the glue storage regions.

5. The optical imaging lens according to claim 1, wherein 35 degrees/mm≤α/SP_W≤610 degrees/mm, where α is an angle of inclination relative to the optical axis of any one of the first inclined plane, the second inclined plane, and the third inclined plane, and SP_W is a width of the first propping surface in a radial direction of the optical axis.

6. The optical imaging lens according to claim 1, wherein from a portion of the object-side surface of the mounting portion of the first lens element counting from the object side towards the image side closest to the object side to a portion of the image-side surface of the first lens element counting from the image side towards the object side closest to the image side, a maximum height MTL is provided along the optical axis, from a portion of the object-side surface of the optical portion of the first lens element counting from the object side towards the image side closest to the object side to a portion of the image-side surface of the first lens element counting from the image side towards the object side closest to the image side, a maximum height OTL is provided along the optical axis, and the optical imaging lens satisfies 0.01mm≤MTL-OTL≤0.07mm.

7. The optical imaging lens according to claim 1, wherein the mounting portions of the entire optical imaging lens are further reinforced by adding additional glue.

8. The optical imaging lens according to claim 1, wherein an external shape of the mounting portion of the first lens element counting from the image side towards the object side is square.

9. The optical imaging lens according to claim 1, wherein the optical imaging lens comprises a lens barrel accommodating a front lens element, a spacer, and a rear lens element of the optical imaging lens from the object side to the image side, and the spacer is arranged between the front lens element and the rear lens element and satisfies 0.2 mm≤THKA≤1.3 mm, where THKA is a maximum distance from the mounting portion of the front lens element to the mounting portion of the rear lens element in parallel to the optical axis.

10. The optical imaging lens according to claim 1, wherein light-absorbing films are individually arranged on the mounting portions of the lens elements.

11. The optical imaging lens according to claim 10, wherein a thickness of each light-absorbing film falls within a range of 0.001 mm to 0.05 mm.

12. The optical imaging lens according to claim 1, further comprising a holder for fixing the lens element closest to the image side.

13. The optical imaging lens according to claim 1, wherein the first propping surface satisfies 0.08 mm≤SP_W≤0.31 mm, where SP_W is a width of the first propping surface in a radial direction of the optical axis.

14. The optical imaging lens according to claim 1, wherein the optical imaging lens satisfies 3%≤(RSP2−RSP1)/RSP2≤14.2%, where RSP1 is a shortest distance from the optical axis to the first propping surface, and RSP2 is a farthest distance from the optical axis to the first propping surface.

15. The optical imaging lens according to claim 1, wherein the optical imaging lens satisfies 5≤GS_AL/D/10≤113, where D is a distance that each glue storage region is retracted from the first propping surface and the first inclined surface.

16. The optical imaging lens according to claim 1, wherein a groove is provided between the second inclined surface and the optical axis.
